(19) United States
(12) Patent Application Publication
(10) Pub. No.: US 2017/0120974 A1
(43) Pub. Date: May 4, 2017

(54) BICYCLE FLOOR RACK

(71) Applicant: Paola PERUZZO, Rosa' (IT)

(72) Inventor: Paola PERUZZO, Rosa' (IT)

(21) Appl. No.: 15/299,233

(22) Filed: Oct. 20, 2016

(30) Foreign Application Priority Data
Oct. 29, 2015 (IT) 102015000066675

(51) Int. Cl. B62H 3/06; B62H 3/08

(52) U.S. Cl. CPC B62H 3/06; B62H 3/08

(57) ABSTRACT

A bicycle floor rack includes,
a resting base with a positioning opening for a wheel of a bicycle or the like and
a fall arrester fork, which is extended upward, in the active configuration, from the resting base, and is adapted to prevent the lateral fall of a wheel inserted therein. The resting base is made of plastic material. The fork is pivoted to the base and configured to be arranged either in an inactive configuration, lowered onto the resting base, or in an active configuration, rotated upward. The floor rack further includes
reversible elements for locking the fall arrester fork in the active configuration.

### CROSS REFERENCE TO RELATED APPLICATIONS

This application is related to and claims the benefit of Italian Patent Application No. 102015000066675, filed on Oct. 29, 2015, the contents of which are herein incorporated by reference in their entirety.

### TECHNICAL FIELD

The present disclosure relates to a bicycle floor rack.

### BACKGROUND

Bicycle floor racks are currently known and widespread for the support of a single bicycle which comprise
a resting base, constituted by metallic tubular elements that are variously bent and mutually welded or bolted and shaped so as to form a positioning opening for a bicycle wheel or the like,
a fall arrester fork, which is extended upward in the active configuration from the resting base and is adapted to prevent the lateral fall of a wheel inserted therein; this fall arrester fork also is composed of metallic tubular elements, normally two parallel tubular elements and one curved terminal tubular element that is adapted to rigidly connect the parallel tubular elements.

The fork is generally coupled in a fixed and stable manner to the base by welding or is coupled by means of threaded elements.

These bicycle floor racks are convenient since they are particularly suitable for home use, for example in a garage where it is necessary to support a bicycle in a tidy manner.

Although these bicycle racks are widespread and appreciated, they have drawbacks.

A first drawback is linked to the structure substantially constituted by metallic tubular elements, which therefore have a certain weight and must be first bent and then mutually fixed so as to form the bicycle rack.

In particular, the fall arrester fork has its parallel tubular elements joined by a metallic tubular portion that is curved through 180° and affects in a relatively important manner the overall production costs of the finished bicycle rack.

These known bicycle racks are therefore relatively onerous both in terms of material used and in terms of processes and labor for assembly.

Moreover, these known bicycle racks have a substantially L-shaped contour that defines a certain space occupation when, if they are not being used, it is necessary to put them away on a shelf or in general store them in a tight containment compartment.

The space occupation of conventional bicycle racks is a drawback also during storage and transport for manufacturers, distributors and retailers.

### SUMMARY

The aim of the present disclosure is to provide a bicycle floor rack that is capable of obviating the mentioned drawbacks of conventional bicycle racks.

Within this aim, the disclosure provides a bicycle rack that is simpler and more economical in terms of production of the components and of assembly.

The disclosure further provides a bicycle rack that is easier to put away and store during periods of nonuse.

The disclosure also provides a bicycle rack with a functionality and stability that are not inferior to those of conventional bicycle racks.

The disclosure provides a bicycle rack that has a smaller space occupation during storage, transport and display for sale.

These advantages that will become better apparent hereinafter, are achieved by a bicycle floor rack, comprising
a resting base with a positioning opening for a wheel of a bicycle or the like,
a fall arrester fork, which is extended upward, in the active configuration, from said resting base, and is adapted to prevent the lateral fall of a wheel inserted therein,

said bicycle floor rack being characterized in that
said fork is pivoted to said base and designed to be arranged either in an inactive configuration, lowered onto the resting base, or in an active configuration, rotated upward,

reversible means for locking said fall arrester fork in the active configuration being provided.

### BRIEF DESCRIPTION OF THE DRAWINGS

Further characteristics and advantages of the disclosure will become better apparent from the description of a preferred but not exclusive embodiment of the bicycle rack according to the disclosure, illustrated by way of nonlimiting example in the accompanying drawings, wherein:

FIG. 1 is a perspective view of a bicycle rack according to the disclosure;

FIG. 2 is a perspective view of a detail of the bicycle rack according to the disclosure in the active configuration;

FIG. 3 is a sectional side view of the detail of FIG. 2;

FIG. 4 is a perspective view of a detail of the bicycle rack according to the disclosure in an intermediate configuration;

FIG. 5 is a sectional side view of the detail of FIG. 4;

FIG. 6 is a sectional side view of a detail of the bicycle rack according to the disclosure in the inactive or nonuse configuration;

FIG. 7 is a perspective view of the bicycle rack according to the disclosure in the inactive or nonuse configuration;

FIG. 8 is a perspective view of a further detail of the bicycle rack according to the disclosure in an active configuration;

FIG. 9 is a perspective view of the bicycle rack according to the disclosure in a constructive variation;

FIG. 10 is a view of another constructive variation of the bicycle rack according to the disclosure; and

FIG. 11 is a view of a detail of a further constructive variation of the bicycle rack according to the disclosure.

### DETAILED DESCRIPTION OF THE DRAWINGS

With reference to the figures, a bicycle floor rack according to the disclosure is designated generally by the reference numeral 10.

The bicycle rack 10 comprises:
a resting base 11 with a positioning opening 12 for a wheel of a bicycle or the like,
a fall arrester fork 13, which is extended upward, in the active configuration, from the resting base 11, and is adapted to prevent the lateral fall of a wheel inserted therein.

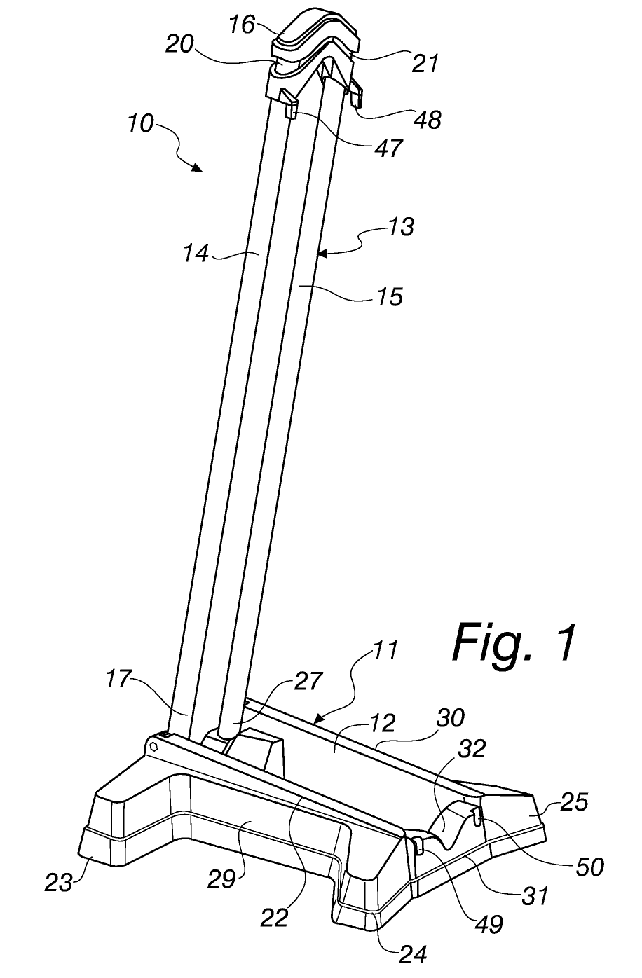

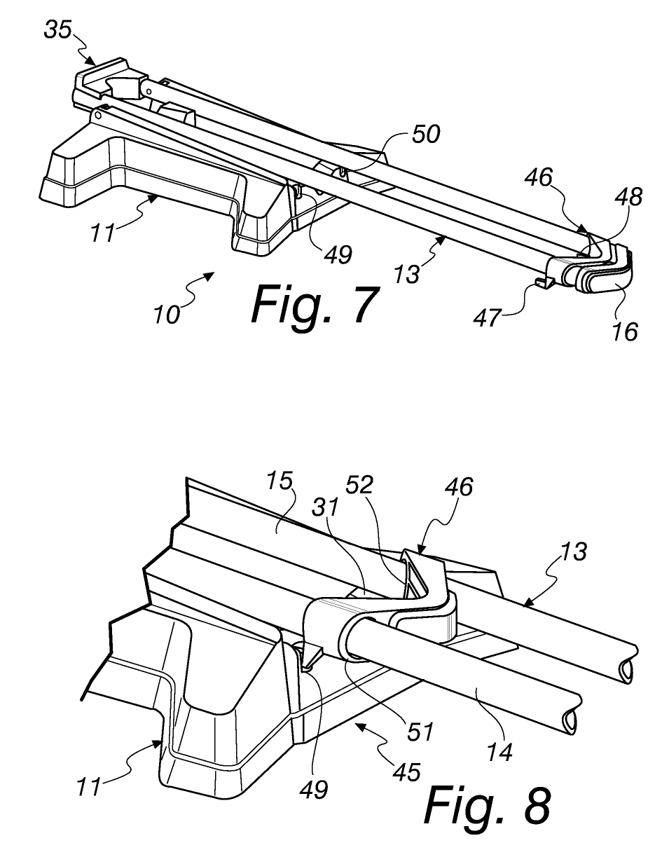

The particularity of the bicycle floor rack 10 according to the disclosure resides in that
the resting base 11 is made of plastic material,
the fork 13 is pivoted to said base and is designed to be arranged either in an inactive configuration, lowered onto the resting base 11, such as for example in FIG. 7, or in an active configuration, rotated upward, such as for example in FIG. 1.

Means for the reversible locking of the fall arrester fork 13 in the active configuration are also present and are described better hereinafter.

The bicycle rack 10 also comprises reversible means for locking the fork 13 in the inactive configuration, which are also described hereinafter.

The fork 13 is composed of two tubular elements 14 and 15 and a connection beam 16.

Each of the tubular elements 14 and 15 has a first end, 17 and 27 respectively, that is pivoted by means of corresponding pivots 18 and 19 to the resting base 11, and has the second opposite end 20 and 21 fixed to the connection beam 16.

The tubular elements 14 and 15 are constituted for example by metallic profiles that have a circular cross-section.

Advantageously, the connection beam 16 is made of plastic material, being simpler and cheaper to provide and assemble with respect to the metallic tubular component bent through 180° that is typical of known bicycle floor racks.

The resting base 11 is constituted by a substantially annular body 22, which comprises for example four walls which are opposite in pairs, with four lateral angular tabs 23, 24, 25 and 26 for stabilizing the resting, and below which there are anti-slip rubber feet, not shown for the sake of simplicity.

The fork 13 is pivoted at a first front wall 28.

The tubular elements 14 and 15 are pivoted by means of the corresponding pivots 18 and 19 to respective side walls, a second wall 29 and a third wall 30.

The resting base 11 is completed by a fourth rear wall 31, which is provided with a recess 32 for facilitating the access of a bicycle wheel to the central positioning compartment 12 of the resting base 11.

In the present embodiment of the disclosure, described herein by way of nonlimiting example of the disclosure, the reversible means for locking the fall arrester fork 13 in the active configuration, designated generally by the reference numeral 34 in the figures, comprise a first slider 35 that is arranged so as to slide on the tubular elements 14 and 15 of the fork 13 and comprises a rotation preventing tab 36, which is clearly visible in FIGS. 3, 5 and 6 and is designed to be inserted reversibly in a complementarily shaped seat 37 formed on the first front wall 28 of the resting base 11.

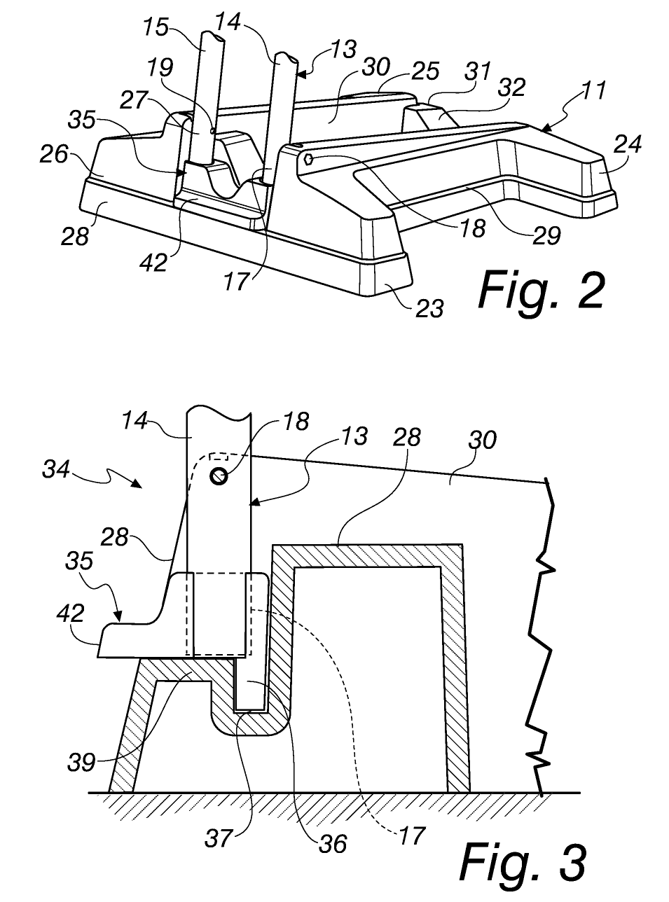

The operation of the reversible locking means 34 provides, in the active configuration of the bicycle rack 10, clearly visible in FIGS. 2 and 3, for the first slider 35 to be lowered at the first ends 17 and 27 with the rotation preventing tab 36 inserted in its seat 37.

In this configuration, the tab 36 cooperates with the walls of the seat 37 so as to prevent the rotation of the fork 13.

The first slider 35 rests against an abutment and stroke limiting portion 39 that is formed on the first wall 28.

In order to allow the rotation of the fork 13 and move the bicycle rack 10 so that it assumes an inactive configuration, i.e., a configuration for nonuse, with reduced space occupation, one proceeds as follows.

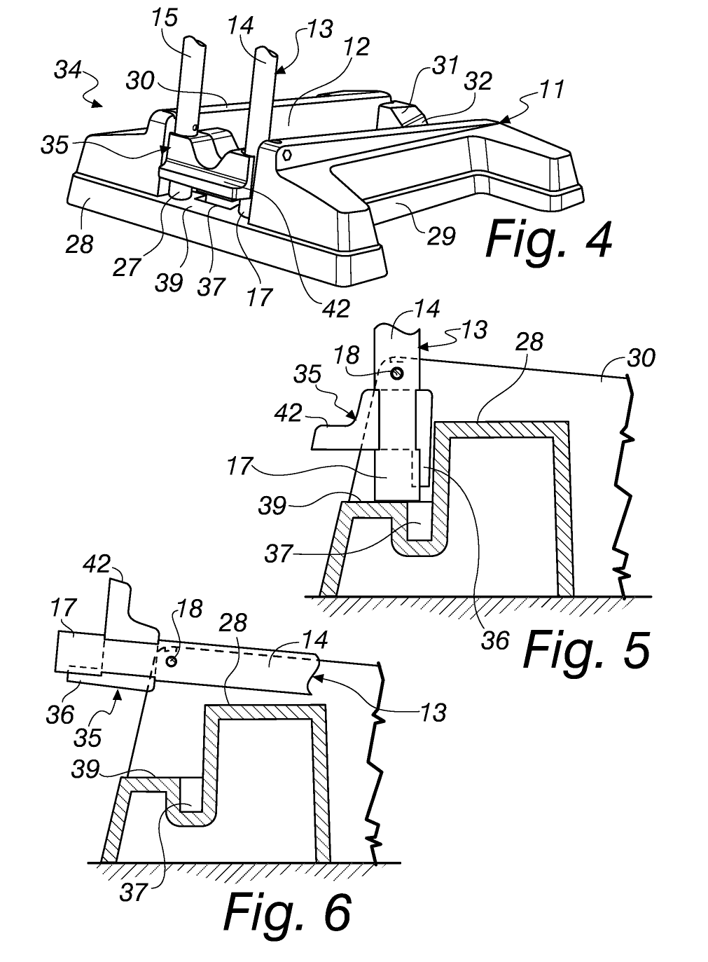

The first slider 35 is raised from its lowered position for resting on the abutment portion 39, extracting the rotation preventing tab 36 from its seat 37; this transition is clearly visible in FIGS. 4 and 5.

With the first slider 35 in this position, the fork 13 is free to rotate, lowering onto the resting base 11, as shown in FIGS. 6 and 7.

The first slider 35 is made of plastic material.

The first slider 35 is constituted by a block having such dimensions as to affect both of the tubular elements 14 and 15 of the fork 13 and has two opposite guiding channels 40 and 41 which are contoured to allow the sliding of the first slider 35 on the tubular elements 14 and 15.

In a constructive variation, not shown for the sake of simplicity, there is a first slider, with a rotation preventing tab, which slides on a single tubular element of the fork and not on both.

The first slider 35 is provided advantageously with a maneuvering protrusion 42, which is designed to facilitate the grip and movement of the first slider 35 on the part of a user.

In the present embodiment of the disclosure, described herein by way of nonlimiting example of the disclosure, the reversible means for locking the fork 13 in the inactive configuration are designated generally by the reference numeral 45 and comprise a second slider 46, which is arranged so as to slide on the tubular elements 14 and 15 and is provided with two lifting prevention tabs 47 and 48 designed to be inserted in corresponding seats 49 and 50 formed on the second rear wall 31, as shown in FIGS. 7 and 8.

Therefore, once the fork 13 has been arranged so as to be rotated downward on the resting base 11, the second slider 46, which is normally arranged in an intermediate position on the fork 13 so as to form an auxiliary resting element for a wheel fitted onto the fork 13, is translated until the lifting prevention tabs 47 and 48 enter the respective seats 49 and 50.

In this lifting prevention configuration, the fork 13 is prevented from rotating and therefore the inactive configuration or nonuse configuration of the bicycle rack 10 is rendered stable and safe.

The second slider 46 is made of plastic material.

The second slider 46 is constituted by a block whose dimensions are such as to affect both of the tubular elements 14 and 15 of the fork 13 and has two opposite guiding channels 51 and 52 that are contoured to allow the sliding of the second slider 46 on the tubular elements 14 and 15.

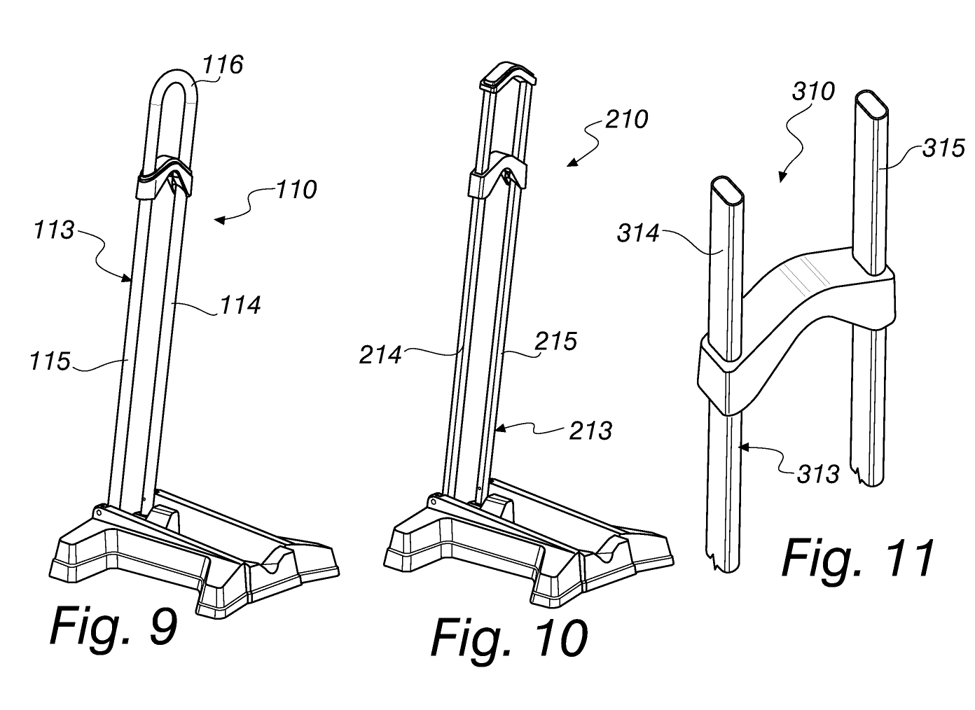

In a constructive variation of a bicycle floor rack according to the disclosure, exemplified in FIG. 9 and designated therein by the reference numeral 110, the fork 113 is composed of two tubular elements 114 and 115 and a connection beam 116 constituted by a tubular metallic element bent through 180°, instead of being constituted by a beam made of plastic material as described above.

In another constructive variation of the bicycle floor rack according to the disclosure, exemplified in FIG. 10 and designated therein by the reference numeral 210, the tubular elements 214 and 215 of the fork 213 have a quadrangular cross-section, for example a square cross-section.

In a further constructive variation of the bicycle floor rack according to the disclosure, exemplified in FIG. 11 and designated therein by the reference numeral 310, the tubular elements 314 and 315 of the fork 313 have an elliptical cross-section.

The cross-section of the tubular elements is generally to be understood as being of any kind depending on the technical and aesthetic requirements of the manufacturer or buyer.

In practice it has been found that the disclosure achieves the intended aims.

In particular, the disclosure provides a bicycle rack that is simpler and cheaper in terms of production of the components and in terms of assembly, by virtue of the resting base made of plastic material and of the other elements made of plastic material, such as the connection beam of the two tubular elements of the fork and the two sliders, the first rotation preventing slider and the second lifting prevention slider.

Moreover, the disclosure provides a bicycle rack that is easier to put away and store during periods of nonuse, by virtue of the reversible means for locking the fork in the active configuration and the reversible means for locking the fork in the inactive or nonuse configuration.

Moreover, the disclosure provides a bicycle rack whose functionality and stability are not inferior to conventional bicycle racks.

Furthermore, the disclosure provides a bicycle rack that has a smaller space occupation during storage, transport and display for sale.

The disclosure thus conceived is susceptible of numerous modifications and variations; all the details may further be replaced with other technically equivalent elements.

In practice, the components and the materials used, so long as they are compatible with the specific use, as well as the contingent shapes and dimensions, may be any according to the requirements and the state of the art.

1. A bicycle floor rack comprising:
a resting base with a positioning opening for a wheel of a bicycle
a fall arrester fork, which is extended upward, in an active configuration, from said resting base, and is adapted to prevent the lateral fall of a wheel inserted therein,
wherein
said fall arrester fork is pivoted to said resting base and configured to be arranged either in an inactive configuration, lowered onto the resting base, or in the active configuration, rotated upward, and
the rack further includes reversible means configured for locking said fall arrester fork in the active configuration.

2. The bicycle rack according to claim 1, wherein said resting base is made of plastic material.

3. The bicycle rack according to claim 1, further comprising reversible means for locking said fork in the inactive configuration.

4. The bicycle rack according to claim 3, wherein said fork is composed of two tubular elements and a connection beam made of plastic material.

5. The bicycle rack according to claim 4, wherein said tubular elements each have a first end pivoted by means of corresponding pivots to the resting base, and the second opposite end fixed to the connection beam.

6. The bicycle rack according to claim 5, wherein said resting base is constituted by a substantially annular body, comprising four walls that are opposite in pairs, said fork being pivoted at a first front wall, the tubular elements being pivoted by means of the corresponding pivots to respective lateral walls, a second wall and a third wall, said resting base being completed by a fourth rear wall.

7. The bicycle rack according to claim 6, wherein said reversible means for locking said fall arrester fork in the active configuration comprise a first slider that is arranged to slide on said tubular elements of the fork and comprises a rotation-preventing tab adapted to be inserted in a reversible manner in a complementarily shaped seat formed on the first front wall of the resting base.

8. The bicycle rack according to claim 7, wherein said first slider is constituted by a block of such dimensions as to affect both tubular elements of the fork and has two opposite guiding channels shaped to allow the first slider to slide on said tubular elements.

9. The bicycle rack according to claim 7, wherein said reversible means for locking said fork in the inactive configuration comprise a second slider, arranged so as to slide on the tubular elements and provided with two lifting prevention tabs designed to be inserted in corresponding seats formed on the second rear wall.

10. The bicycle rack according to claim 9, wherein said second slider is constituted by a block of such dimensions as to affect both tubular elements of the fork and has two opposite guiding channels shaped to allow the second slider to slide on said tubular elements.
